(19) United States
(12) Patent Application Publication
(10) Pub. No.: US 2022/0222648 A1
(43) Pub. Date: Jul. 14, 2022

(54) SYSTEM FOR ELECTRONIC COMPLETION OF A RESOURCE TRANSFER USING A TEMPORARY RESOURCE PATCH

(71) Applicant: BANK OF AMERICA CORPORATION, Charlotte, NC (US)

(72) Inventors: Cynthia A. Frick, Newark, DE (US); Melissa Major Summitt, Charlotte, NC (US); Andrea M. Weisberger, Jacksonville, FL (US); Nicholas Gregory Grant, Garland, TX (US); Mark Trenton Cimijotti, Monroe, NC (US); Khyree B. Bolden, Sicklerville, NJ (US); Steven E. Sinks, Scottsdale, AR (US)

(73) Assignee: BANK OF AMERICA CORPORATION, Charlotte, NC (US)

(21) Appl. No.: 17/146,905

(22) Filed: Jan. 12, 2021

(51) Int. Cl. G06Q 20/32; G06Q 20/40; G06K 19/077

(52) U.S. Cl. CPC G06Q 20/321; G06Q 20/3278; G06K 19/07762; G06Q 20/4014; G06Q 20/3263

(57) ABSTRACT

Embodiments of the invention are directed to a system, method, and computer program product for completion of a resource transfer using a temporary resource patch. The system receives a request for a resource transaction associated with a temporary resource patch. The system determines whether the temporary resource patch can complete the resource transaction. The system executes the transaction if the temporary resource patch can complete the resource transaction.

### FIELD OF THE INVENTION

The present invention is directed to, in general, a novel, proactive approach for completing a resource transaction with a resource patch. Specifically, embodiments of the present invention are directed to wirelessly executing a resource transaction utilizing a temporary resource patch.

### BACKGROUND

When a person desires to complete a resource transaction, the person may have a variety of methods for completing the resource transaction using a physical resource, such as a token or a card, and/or an electronic resource, such as a smartphone. However, these methods for completing a resource transaction require the person to have the physical and/or electronic resource on their persons, which can be cumbersome during certain activities, such as swimming at the beach, where pockets may not be available to store the physical and/or electronic resource. Accordingly, there is a need for systems and methods to improve how resource transactions can be completed.

The previous discussion of the background to the invention is provided for illustrative purposes only and is not an acknowledgement or admission that any of the material referred to is, or was, part of the common general knowledge on the priority date of the application.

### SUMMARY

In one aspect, the present disclosure is directed to a system for wirelessly completing a resource transaction with a temporary resource patch. In one embodiment, the system can comprise at least one memory device; at least one communication device connected to a communications network; at least one processing device operatively coupled to the at least one memory device; and a module stored in the at least one memory device comprising executable instructions. The executable instructions, that when executed by the at least one processing device, can cause the at least one processing device to receive, from a user device, a transmission that indicates the temporary resource patch and an active timeframe that the temporary resource patch is capable of completing one or more resource transactions, the temporary resource patch is configured to communicate with one or more electronic devices via a wireless communications protocol and is configured to be affixed to a surface; receive, at a first time, a transmission that indicates a request for a resource transaction associated with the temporary resource patch, the temporary resource patch is associated with a pre-determined resource allocation; determine, based on the first time being within the active timeframe and based on a remaining portion of the pre-determined resource allocation, whether the temporary resource patch can complete the resource transaction; if the first time is within the active timeframe and if the remaining portion of the pre-determined resource allocation is adequate to complete the resource transaction, execute the resource transaction; and if the first time is not within the active timeframe or if the remaining portion of the pre-determined resource allocation is not adequate to complete the resource transaction, transmit a notification that indicates that the resource transaction cannot be completed.

In another embodiment, and in combination with any of the previous embodiments, the executable instructions further cause the at least one processing device to: receive, from a user device, a transmission that indicates the temporary resource patch, the transmission comprises an identifier associated with the temporary resource patch; associate, based on the identifier, the temporary resource patch with a resource account associated with a user of the user device; and transmit, via a resource application associated with the user device, a notification indicating that the temporary resource patch is associated with the resource account.

In another embodiment, and in combination with any of the previous embodiments, the executable instructions further cause the at least one processing device to: transmit, via the resource application, a query whether the user desires to complete the resource transaction, the notification that indicates that the resource transaction cannot be completed is transmitted via the resource application; receive, via the resource application, a response from the user that indicates that the user desires to complete the resource transaction; if the remaining portion of the pre-determined resource allocation is not adequate to complete the resource transaction, transfer, from the resource account to the temporary resource patch, a quantity of the resource adequate to complete the transaction; if the first time is not within the active timeframe, modify the active timeframe such that the first time is within the active timeframe; and transmit, via the resource application, a notification that indicates that the temporary resource patch is capable of completing the resource transaction.

In another embodiment, and in combination with any of the previous embodiments, the executable instructions further cause the at least one processing device to: receive, via the resource application, an indication that the user desires to modify one or more settings associated with the temporary resource patch, the one or more settings comprise at least one of the pre-determined resource allocation, the active timeframe, a geographical region where the temporary resource patch is active, one or more resource accounts associated with the temporary resource patch, or one or more users associated with the temporary resource patch; transmit, to the temporary resource patch based on the indication that the user desires to modify the one or more settings associated with the temporary resource patch, a transmission that indicates the one or more settings the user desires to modify, the temporary resource patch is configured to modify the one or more settings associated with the temporary resource patch; receive, from the temporary resource patch, an indication that the one or more settings the user desires to modify have been modified; and transmit, via the resource application, a confirmation that indicates that the one or more settings the user desires to modify have been modified.

In another embodiment, and in combination with any of the previous embodiments, the executable instructions further cause the at least one processing device to: receive, via the resource application, an indication that the user desires to associate a password with the temporary resource patch; receive, via the resource application, the password the user desires to associate with the temporary resource patch; transmit, to the temporary resource patch, a transmission that indicates the password the user desires to associate with the temporary resource patch, the temporary resource patch is configured to prevent completion of one or more resource transactions without receiving an indication of the password; receive, from the temporary resource patch, an indication that the temporary resource patch successfully implemented the password; and transmit, via the resource application, a confirmation that indicates that the temporary resource patch is associated with the password.

In another embodiment, and in combination with any of the previous embodiments, the executable instructions further cause the at least one processing device to: receive, via the resource application, an indication that the user desires to de-activate the temporary resource patch; transfer the remaining portion of the pre-determined resource allocation to the resource account associated with the user; store, within a memory resource, data that indicates that the temporary resource patch is de-activated; transmit, to a resource network associated with the temporary resource patch, a notification that indicates that the temporary resource patch is de-activated; and transmit, via the resource application, a confirmation that indicates that the temporary resource patch is de-activated and that the remaining portion of the pre-determined resource allocation was transferred to the resource account associated with the user.

In another embodiment, and in combination with any of the previous embodiments, the temporary resource patch is further configured to be affixed on a person, and the temporary resource patch is further configured to be disposable.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings:

FIG. 1 illustrates an electronic activity processing system and environment;

FIG. 2 illustrates an exemplary system for wirelessly completing a resource transaction with a temporary resource patch;

FIG. 3 illustrates a flowchart of an exemplary method; and

FIG. 4 illustrates an exemplary user interface of a device.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein. Rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more additional things as well. In other words, unless expressly indicated otherwise, as used herein “based on” means “based at least in part on” or “based at least partially on.”

In some embodiments, an “entity” refers to an organization, a company, a group, an institution, a business or the like associated with initiating and/or performing electronic activities. Typically, the entity comprises systems, devices, applications and/or the like for initiating and/or performing electronic activities. In some embodiments, the entity initiates and/or performs electronic activities in response to receiving instructions from an associated user. In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account (e.g., a resource account) with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user account that includes only personal information associated with the user, or the like. The account is associated with and/or maintained by an entity. In other embodiments, an “entity” may not be a financial institution. Examples for non-financial entities include cloud computing systems, database systems, block chain systems for data processing, and the like.

Unless specifically limited by the context, an “electronic activity”, “user activity”, “transaction” or “activity” refers to activities associated with electronic resources, such as the user's resources. In some embodiments, the electronic activity refers to resource transfers between resources, e.g., a transfer of a resource value from a first resource and a second resource. For example, the electronic activity may refer to transmission of resource value comprising predetermined data (e.g., files, text, images, etc.) from a first resource (e.g., a user device, a database, a server, a cloud storage system, etc.) to a second resource (e.g., another device, database, etc.). Typically, a first system (e.g., a user device, a networked device, a computing device, etc.), for example, based on receiving instructions from a user, transmits activity parameters (e.g., location of a file, time of transmission, unique identifier of a source resource system, certificates of a target resource system, authentication information, etc.) to a recipient system (e.g., a system associated with one or more of the resources, an entity system, etc.) which then performs the electronic activity (e.g., transfer of the file from the source resource system to the target resource system). As another example, in some embodiments, the electronic activity refers to transfer of a resource value comprising financial resources (e.g., a predetermined transfer amount, a resource transaction, etc.) from a first resource (e.g., a source account, a user account, etc.) to a second resource (e.g., a target account). Typically, a first system (e.g., a user device, a temporary resource patch, etc.), for example, based on receiving instructions from a user, transmits activity parameters (e.g., the transfer amount, time and date of the transfer, unique identifiers of the source user account and the target user account, etc.) to a recipient system (e.g., a financial institution associated with the source account and/or the target account) which then performs the electronic activity (e.g., transfer of the predetermined amount from the source account to the target account).

As such, in some embodiments, an electronic activity or a user activity may refer to a purchase of goods or services, a return of goods or services, a payment transaction, a credit transaction, or other interaction involving a user's resources (e.g., a bank account, a temporary resource account, etc.). As another example, in some embodiments, a user activity may refer to viewing account balances, modifying user information and contact information associated with an account, modifying alert/notification preferences, viewing transaction/activity history, transferring/redeeming loyalty points, and the like. In some embodiments, the user activity is associated with an entity application stored on a user device, for example, a digital wallet application, a mobile/online banking application, a merchant application, a browser application, a social media application and the like. Typically, a user activity is an electronic transaction or electronic activity in which the user is employing a mobile device, computing device, a wireless resource patch, or other electronic device to initiate, execute and/or complete the activity.

As used herein, a “bank account” or a “resource account” refers to a credit account, a debit/deposit account, or the like. Although the phrase “bank account” includes the term “bank,” the account need not be maintained by a bank and may, instead, be maintained by other financial institutions. For example, in the context of a financial institution, a user activity or transaction may refer to one or more of a sale of goods and/or services, an account balance inquiry, a rewards transfer, an account money transfer, opening a bank application on a user's computer or mobile device, a user accessing their e-wallet (e.g., mobile wallet) or online banking account or any other interaction involving the user and/or the user's device that is detectable by the financial institution. As further examples, a user activity may occur when an entity associated with the user is alerted via the transaction of the user's location. A user activity may occur when a user accesses a building, uses a rewards card, uses a wireless resource patch, and/or performs an account balance query. A user activity may occur as a user's device establishes a wireless connection, such as a Wi-Fi connection, with a point-of-sale terminal. In some embodiments, a user activity may include one or more of the following: purchasing, renting, selling, and/or leasing goods and/or services (e.g., groceries, stamps, tickets, DVDs, vending machine items, etc.); withdrawing cash; making payments (e.g., paying monthly bills; paying federal, state, and/or local taxes, etc.); sending remittances; transferring balances from one account to another account; loading money onto Stored Value Cards (SVCs), wireless resource patches, and/or prepaid cards; donating to charities; and/or the like.

As used herein, an “online banking account” or an “online resource account” is an account that is associated with one or more user accounts at a financial institution. For example, the user may have an online banking account that is associated with the user's checking account, savings account, investment account, and/or credit account at a particular financial institution. Authentication credentials comprising a username and password are typically associated with the online banking account and can be used by the user to gain access to the online banking account. The online banking account may be accessed by the user over a network (e.g., the Internet) via a computer device, such as a personal computer, laptop, or mobile device (e.g., a smartphone, tablet, a smartwatch, etc.). The online banking account may be accessed by the user via a mobile or online banking website or via a mobile or online banking application. A customer may access an online banking account to view account balances, view transaction history, view statements, transfer funds, and pay bills. More than one user may have access to the same online banking account. In this regard, each user may have a different username and password. Accordingly, one or more users may have a sub-account associated with the online banking account.

A “user” may be an individual or a group of individuals associated with an entity that provides the system for assessing network authentication requirements. In some embodiments, the “user” may be a financial institution user (e.g., an account holder or a person who has an account (e.g., a banking account, a credit account, a wireless resource patch, etc.)). In one aspect, a user may be any financial institution user seeking to perform user activities associated with the financial institution or any other affiliate entities associated with the financial institution. In some embodiments, the user may be an individual who may be interested in opening an account with the financial institution or may be an individual desiring to complete a resource transaction via the financial institution. In some other embodiments, a user may be any individual who may be interested in the authentication features offered by the financial institution/entity. In some embodiments, a “user” may be a financial institution employee (e.g., an underwriter, a project manager, an IT specialist, a manager, an administrator, an internal operations analyst, bank teller, etc.). For purposes of this invention, the term “user” and “customer” may be used interchangeably.

With advancements in technology infrastructures and wireless communication implementation, electronic devices such as transaction terminals, including point of sale terminals, portable multi-function devices, such as laptop computers, tablet computers, mobile phones, smartphones, wearable devices and the like are common. Typically, individuals may also have a mobile user device with them. These electronic devices may enable performance of user activities (e.g., financial activities, purchases, resource transfers, accessing resource data stored at other systems and databases, etc.) based on requisite authorization. These electronic devices may also be configured to allow the user to perform the one or more user activities, transactions or resource transfers through an application, accept authentication credentials from the user, transmit authentication credentials for validation at external systems, and the like.

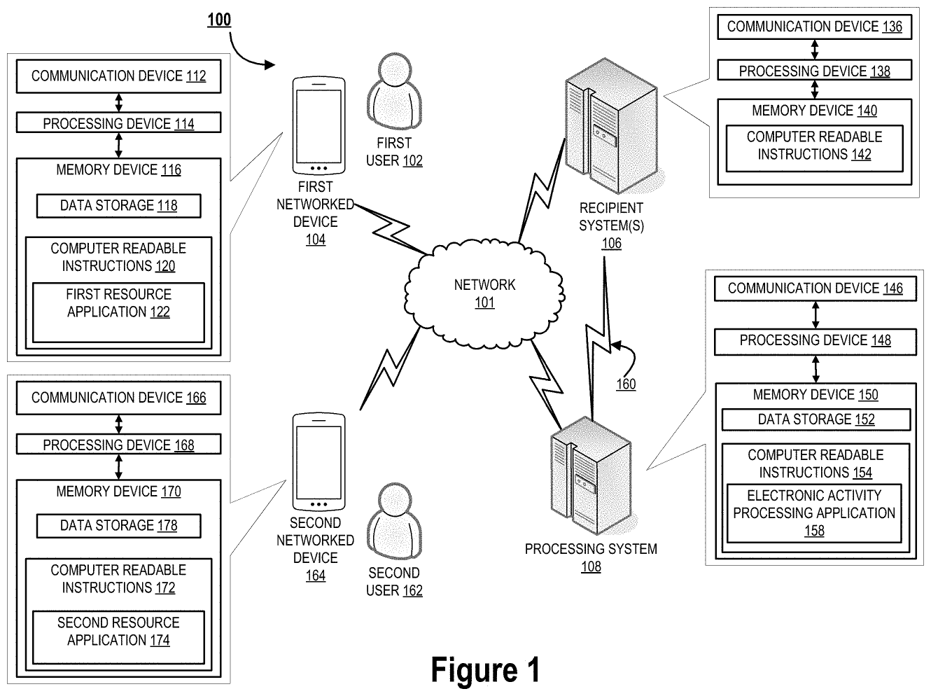

Embodiments of the present invention address the above needs and/or achieve other advantages by providing apparatuses (e.g., a system, computer program product, and/or other devices) and methods for wirelessly completing a resource transaction with a temporary resource patch, as will be described in detail elsewhere in the specification. FIG. 1 illustrates an electronic activity processing system environment 100, in accordance with some embodiments of the present invention. FIG. 1 provides a unique system that includes specialized servers and systems, communicably linked across a distributive network of nodes required to perform the functions of processing resource transfer activities.

As illustrated in FIG. 1, a processing system 108, or electronic activity processing system 108 or application server (e.g., a financial institution system 108) is operatively coupled, via a network 101 to user devices, such as a first networked device 104, a second networked device 164, and the like, to the recipient system 106 (e.g., another second financial institution system 106) and/or to one or more secondary systems. In this way, the processing system 108 can send information to, and receive information from, the user devices (e.g., the first networked device 104, the second networked device 164, etc.), the recipient system 106, and one or more secondary systems. FIG. 1 illustrates only one example of an embodiment of the system environment 100, and it will be appreciated that in other embodiments of the systems, devices, or servers may be combined into a single system, device, or server, or be made up of multiple systems, devices, or servers.

The network 101 may be a system specific distributive network receiving and distributing specific network feeds and identifying specific network associated triggers. The network 101 may also be a global area network (GAN), such as the Internet, a wide area network (WAN), a local area network (LAN), or any other type of network or combination of networks. The network 101 may provide for wireline, wireless, or a combination wireline and wireless communication between devices on the network 101. In some embodiments, the network 101 may enable communication between devices thorough near-field communication, transmission of electromagnetic waves, sound waves or any other suitable means.

In some embodiments, a first user 102 is an individual that has a user device, e.g., the first networked device 104, such as a mobile phone, tablet, computing device, etc., and who seeks to perform one or more electronic activities or user activities. In some embodiments, the second user 162 is another individual that has a user device, e.g., the second networked device 164, such as a mobile phone, tablet, computing device, etc., and who seeks to perform one or more electronic activities or user activities.

FIG. 1 also illustrates the first networked device 104. The first networked device 104 (also referred to as a first user device or a user device, which may be associated with the first user 102) may refer to a device or a combination of devices that are configured to provide data to the first user 102 (e.g., visual data, sound data, haptic data, etc.) and/or capture (e.g., receive and/or process) one or more instructions, inputs, authentication credentials, and the like from the first user 102 such as a computing device (e.g., a mobile device, a smart phone, a laptop computer and/or another computing device), smart devices (e.g., smart TVs, smart doors, smart speakers, personal digital assistant devices), wearable devices (e.g., smart watches, fitness devices, virtual/augmented reality devices), Global Positioning System (GPS) devices, proximity/location sensors/beacon devices, visual capture devices and/or the like to capture authentication credentials associated with the user. The first networked device 104 may be, for example, a desktop personal computer, a mobile system, such as a cellular phone, a smartphone, personal data assistant (PDA), laptop, etc.

The first networked device 104 comprises a communication device 112 comprising input/output components and/or sensors, a processing device 114, and a memory device 116. As used herein, the term “processing device” generally includes circuitry used for implementing the communication and/or logic functions of the particular system. For example, a processing device may include a central processing unit (CPU), a digital signal processor device, a microprocessor device, and various analog-to-digital converters, digital-to-analog converters, and other support circuits and/or combinations of processing devices. Control and signal processing functions of the system are allocated between these processing devices according to their respective capabilities. The memory device 116 can be a non-transitory computer-readable storage medium. The first networked device 104 may comprise other components that are not illustrated, such as components configured for location determination/navigation (GPS devices, accelerometers, etc.), for authentication (fingerprint scanners, microphones, iris scanners, etc.), for image capture (cameras, AR devices, etc.), for display (screens, touchscreens, hologram projectors, etc.), and other purposes. The first networked device 104 comprises a computing system that enables the user to perform one or more user activities, e.g., initiating one or more electronic activities such as resource transfers, payment requests, etc. via one or more applications associated with the first networked device 104. For example, the first networked device 104 can be configured to communicate with a temporary resource patch associated with the first user 102. As used herein, “temporary” can comprise any length of time (e.g., minutes, hours, days, weeks, months, years, etc.).

The processing device 114 is operatively coupled to the communication device 112 and the memory device 116. The processing device 114 utilizes the communication device 112 to communicate with the network 101 and other devices on the network 101, such as, but not limited to, the processing system 108. For example, the communication device 112 can comprise a modem, a communications interface, a server, or other device for communicating with other devices on the network 101. Additionally, the communication device 112 can be configured to communicate with other devices using wireless communications (e.g., Near Field Communications (NFC), Bluetooth, Wi-Fi, cellular, etc.) For example, the communication device 112 can be configured to communicate with one or more temporary resource patches.

The first networked device 104 comprises the memory device 116, which can comprise computer-readable instructions 120 and data storage 118, which in one embodiment includes the computer-readable instructions 120 of a first resource application 122. The computer-readable instructions 120 can be computer-executable instructions that are executable by a processor and/or a processing device (e.g., the processing device 114). In some embodiments, the first networked device 104 may refer to multiple user devices that may be configured to communicate with each other, with the processing system, and/or other systems via the network 101. In some embodiments, the processing system 108 transmits data associated with the first resource application 122 to and/or causes the processing device 114 to install/store the first resource application 122 on the first networked device 104. In some embodiments, the first resource application 122, when executed by the processing device 114, is configured to cause the first networked device 104 to perform one or more actions and/or steps described herein. In some embodiments, the first resource application 122 is similar to the electronic activity processing application 158 described below.

The first resource application 122 may be a standalone application configured for receiving data/instructions associated with an electronic activity from a user (e.g., via a user interface of the first resource application 122), transmitting electronic data and/or executing an action associated with the resource network as described herein, or the first resource application 122 may refer to one or more existing applications on the user device that are configured to perform one or more of these steps. In some embodiments, the first resource application 122 may be associated with a resource network application that facilitates the first user 102 interacting with a resource network. For example, the first resource application 122 may be a payment network application structured for person-to person (P2P) payments and/or real time payments (RTP), with the second user 162 being a part of the same payment network and having a corresponding payment network application structured for person-to person (P2P) payments and/or real time payments (RTP) (e.g., with the second resource application 174). As another, example, the first resource application 122 can be configured to communicate with and/or configure a temporary resource patch.

In some embodiments, the resource network may comprise the processing system 108 and/or a financial institution system may transmit electronic communications to the first networked device 104, which may be configured to cause the first resource application 122 to perform one or more functions, actions, or steps associated with electronic processing. For example, the electronic communications may cause the first resource application 122 to trigger one or more sensors or input devices of the first networked device 104 to capture and/or receive an authentication credential associated with the first user 102 based on instructions received via the electronic communications. As an example, the first resource application 122 can be configured to capture an input from the first user 102 that indicates that the first user desires to modify one or more settings associated with a temporary resource patch, as well as that indicates that the first user 102 desires to complete a resource transaction associated with a temporary resource patch. The electronic communications may originate from the processing system 108, or another computing device in the system 100, to cause the first networked device 104 to request user input/information from the first user 102, and the like.

FIG. 1 also illustrates the second networked device 164. The second networked device 164 (also referred to as a second user device or a user device, which may be associated with the second user 162) may refer to a device or a combination of devices that are configured to capture (e.g., receive and/or process) one or more instructions, inputs, authentication credentials, and the like from the second user 162 such as a computing device (e.g., a mobile device, a smartphone, a laptop computer and/or another computing device), smart devices (e.g., smart TVs, smart doors, smart speakers, personal digital assistant devices), wearable devices (e.g., smart watches, fitness devices, virtual/augmented reality devices), GPS devices, proximity/location sensors/beacon devices, visual capture devices and/or the like to capture authentication credentials associated with the user. The second networked device 164 may be, for example, a desktop personal computer, a mobile system, such as a cellular phone, smartphone, personal data assistant (PDA), laptop, or the like.

The second networked device 164 comprises a communication device 166 comprising input/output devices and/or sensors, a processing device 168, and a memory device 170. The memory device 170 can be a non-transitory computer-readable storage medium. The second networked device 164 may comprise other devices that are not illustrated, such as devices that are configured for location determination/navigation (e.g., GPS devices, accelerometers, etc.), for authentication (e.g., fingerprint scanners, microphones, iris scanners, etc.), for image capture (e.g., cameras, AR devices, etc.), for display (e.g., screens, touchscreens, hologram projectors, etc.), and other purposes. The second networked device 164 is a computing system that enables the user to perform one or more user activities, e.g., initiating one or more electronic activities such as resource transfers, payment requests, etc. via one or more applications associated with the second networked device 164.

The processing device 168 is operatively coupled to the communication device 166 and the memory device 170. The processing device 168 utilizes the communication device 166 to communicate with the network 101 and other devices on the network 101, such as, but not limited to the processing system 108. For example, the communication device 166 can comprise a modem, a communications interface, a server, or other device for communicating with other devices on the network 101. Additionally, the communication device 112 can be configured to communicate with other devices using wireless communications (e.g., Near Field Communications (NFC), Bluetooth, Wi-Fi, cellular, etc.) For example, the communication device 112 can be configured to communicate with one or more temporary resource patches.

The second networked device 164 comprises the memory device 170, which can comprise computer-readable instructions 172 and data storage 178, which in one embodiment includes the computer-readable instructions 172 of a second resource application 174. The computer-readable instructions 172 can be computer-executable instructions that are executable by a processor and/or a processing device (e.g., the processing device 168). In some embodiments, the second networked device 164 may refer to multiple user devices that may be configured to communicate with each other, with the processing system, and/or other systems via the network 101. In some embodiments, the processing system 108 transmits data associated with the second resource application 174 to and/or causes the processing device 168 to install/store the second resource application 174 on the second networked device 164. In some embodiments, the second resource application 174, when executed by the processing device 168, is configured to cause the second networked device 164 to perform one or more actions and/or steps described herein. In some embodiments, the second resource application 174 is similar to the electronic activity processing application 158 described below.

The second resource application 174 may be a standalone application configured for receiving data/instructions associated with an electronic activity from a user (e.g., via a user interface of the second resource application 174), transmitting electronic data and/or executing an action associated with the resource network as described herein, or the second resource application 174 may refer to one or more existing applications on the second user device 164 that are configured to perform one or more of these steps. In some embodiments, the second resource application 174 associated with the second user 162 may be associated with a resource network. For example, the second resource application 174 may be a payment network application structured for person-to person (P2P) payments and/or real time payments (RTP), with the first user 102 being a part of the same payment network and having a corresponding payment network application structured for person-to person (P2P) payments and/or real time payments (RTP) (e.g., with the first resource application 122). As another example, the second resource application 174 can be configured to communicate with and/or configure a temporary resource patch.

In some embodiments, the processing system 108 and/or a financial institution system may transmit electronic communications to the second networked device, which may be configured to cause the second resource application 174 to perform one or more functions or steps associated with electronic processing. For example, the electronic communications may cause the second resource application 174 to trigger one or more sensors or input devices of the second networked device 164 to capture and/or receive an authentication credential associated with the second user 162 based on instructions received via the electronic communications. As an example, the first resource application 122 can be configured to capture an input from the first user 102 that indicates that the first user desires to modify one or more settings associated with a temporary resource patch, as well as that indicates that the first user 102 desires to complete a resource transaction associated with a temporary resource patch. The electronic communications may originate from the processing system 108, or another computing device in the system 100, to cause the second networked device 164 to request user input/information from the second user 162, and the like.

As further illustrated in FIG. 1, the processing system 108 or the electronic activity processing system 108 generally comprises a communication device 146, a processing device 148, and a memory device 150. The memory device 150 can be a non-transitory computer-readable storage medium. As used herein, the term “processing device” generally includes circuitry used for implementing the communication and/or logic functions of the particular system. For example, a processing device may include a central processing unit (CPU), a digital signal processor device, a microprocessor device, and various analog-to-digital converters, digital-to-analog converters, and other support circuits and/or combinations of processing devices. Control and signal processing functions of the system are allocated between these processing devices according to their respective capabilities. The processing system 108 may be configured to operate one or more software programs and/or applications based on computer-readable instructions 154, which may be stored in a memory device 150. The computer-readable instructions 154 can be computer-executable instructions that are executable by a processor and/or a processing device (e.g., the processing device 148).

The processing device 148 is operatively coupled to the communication device 146 and the memory device 150. The communication device 146 can comprise a modem, a server, a communications interface, or other device for communicating with other devices on the network 101. The processing device 148 uses the communication device 146 to communicate with the network 101 and other devices on the network 101, such as, but not limited to the recipient system 106, the user device(s) 104, 164, and/or additional devise in communication with the network 101.

The processing system 108 comprises computer-readable instructions 154 stored in the memory device 150, which in one embodiment includes the computer-readable instructions 154 of an electronic activity processing application 158. In some embodiments, the memory device 150 includes data storage 152 for storing data associated with the processing system 108. For example, the data can be associated with the electronic activity processing application 158, the system 108, and/or the system 100. In some embodiments, executing the computer readable instructions of the electronic activity processing application 158 causes the processing device 148 to perform one or more steps and/or actions for electronic activity processing described herein.

The electronic activity processing application 158 may receive electronic activity data from the user devices, e.g., the first networked device 104 and/or the second networked device 164. In some embodiments, the processing system 108 may retrieve user authentication information, capture device information, financial information, identifiers, resource account information, and the like from the user devices (e.g., the first networked device 104, the second networked device 164, etc.) and/or the recipient system 106. In this way, the electronic activity processing application 158 may communicate with the recipient system 106, the user devices (e.g., the first networked device 104, the second networked device 164, etc.), a resource network, merchant systems, and other third-party systems. For example, the electronic activity processing application 158 can be configured to execute a resource transaction associated with a temporary resource patch and a user (e.g., the first user 102, the second user 162).

In some embodiments, the electronic activity processing application 158 may control the functioning of the first networked device 104 and/or the second networked device 164. In some embodiments, the electronic activity processing application 158 may comprise computer-readable instructions 154 or computer-readable program code, that when executed by the processing device 148, causes the processing device 148 to perform one or more steps described herein and/or transmit data to other systems and devices to cause the systems and devices to perform specific tasks. For example, the electronic activity processing application 158 may initiate a transfer of resources from a first resource to a second resource. As another example, the electronic activity processing application 158 can be configured to modify one or more settings associated with a temporary resource patch, as well as execute a transaction between the temporary resource patch and another party, such as a merchant, another user, a different financial institution, and the like.

As illustrated in FIG. 1, the recipient system 106 is connected to the processing system 108 and may be associated with a resource network and/or a financial institution network (e.g., a recipient bank for a resource transfer activity, an account transfer electronic activity, etc.). The recipient system 106 may refer to a financial institution system, a transaction terminal or other devices or systems associated with performing the activity. While only one recipient system 106 is illustrated in FIG. 1, it is understood that the system 100 can include multiple recipient systems 106.

As shown, the recipient system 106 is substantially similar to the processing system 108. The recipient system 106 generally comprises a communication device 136, a processing device 138, and a memory device 140. The memory device 140 can be a non-transitory computer-readable storage medium. The recipient system 106 comprises computer-readable instructions 142 stored in the memory device 140, which in one embodiment includes the computer-readable instructions 142 of a finalization authorization application. The finalization authorization application can be configured to execute a resource transaction (e.g., authorize a payment to the recipient system from a user). The computer-readable instructions 142 can be computer-executable instructions that are executable by a processor and/or a processing device (e.g., the processing device 138). In some embodiments, the processing system 108 (e.g., based on executing the application 158) transmits and/or causes the processing device 138 to install/store the finalization authorization application on the recipient system 106. In some embodiments, the finalization authorization application, when executed by the processing device 138 is configured to cause the recipient system 106 to perform one or more steps described herein (e.g., transfer resources from a first resource to a second resource, modify one or more settings associated with a temporary resource patch, determine whether a temporary resource patch is capable of executing a resource transaction, etc.). In some embodiments, the finalization authorization application is similar to the electronic activity processing application 158 described above. The recipient system 106 may communicate with the processing system 108 to receive static activity data sets, indicate processing of static activity data sets, indicate completion of an electronic activity, request validation of authentication credentials, confirm a resource transfer, and the like. The processing system 108 may communicate with the recipient system 106 via a secure connection 160 generated for secure encrypted communications between the two systems. In some embodiments, the secure connection 160 may be an operative communication link/channel established via the network 101.

It is understood that the systems, servers, and devices described herein illustrate one embodiment of the invention. It is further understood that one or more of the systems, servers, and devices can be combined in other embodiments and still function in the same or similar way as the embodiments described herein.

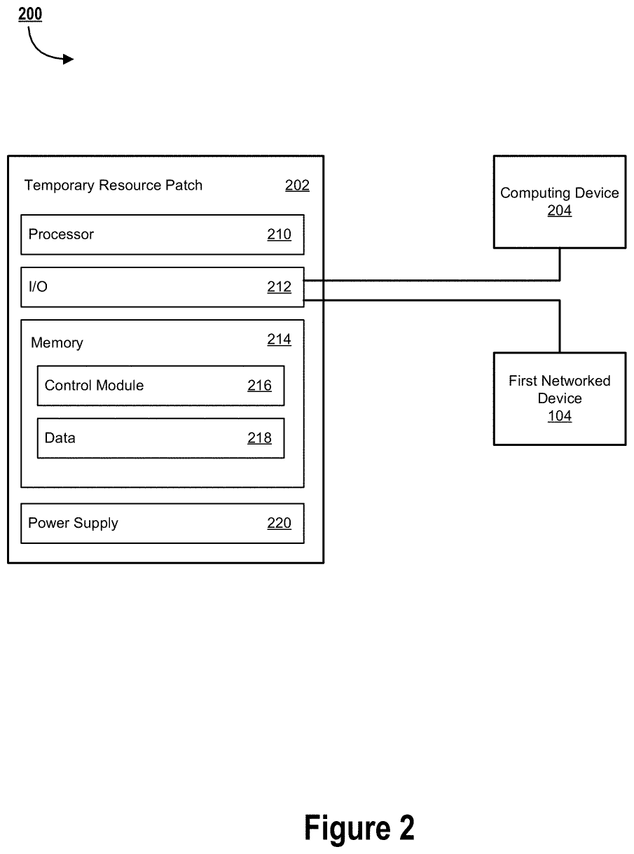

FIG. 2 illustrates an exemplary system 200 for wirelessly completing a resource transaction with a temporary resource patch. As shown, the system 200 comprises a temporary resource patch 202 (may be referred to herein as resource patch 202), a computing device 204, and the first networked device 104. The resource patch 202 comprises a processor 210, an input output interface (I/O) 212, a memory 214, and a power supply 220. In some embodiments, the resource patch 202 can include additional components such as a global positioning system (GPS), motion detectors, and so forth. While a single processor 210 is shown for ease of explanation, a person skilled in the art would appreciate that the resource patch 202 can include any number of processors 210. Further, the resource patch 202 can comprise one or more microcontrollers, as well as integrated circuits (ICs).

The processor 210 can perform various tasks, such as retrieving information stored in the memory 214, and executing various software modules. For example, the processor 210 can execute the control module 216 that provides instructions and/or settings for the temporary resource patch 202. As an example, the control module 216 can determine and/or set one or more settings and/or operational parameters for the resource patch 202. In one example, the processor 210 can be a microcontroller. In one embodiment, the processor 210 can be a microcontroller.

As shown, the resource patch 202 is communicatively coupled via the I/O 212 with the computing device 204 and the first networked device 104. The I/O 212 can include any type of suitable hardware for communicating with the computing device 204 and/or the first networked device 104. For example, the I/O 212 can include direct connection interfaces such as Ethernet and Universal Serial Bus (USB), as well as wireless communications, including but not limited to, Wi-Fi, Bluetooth, cellular, Radio Frequency (RF) (e.g., Radio-Frequency Identification (RFID)), Near Field Communications (NFC), and so forth. For example, the control module 216 can communicate via the I/O 212 with another device (e.g., the computing device 204, the first networked device 104, etc.) to determine one or more settings and/or operational parameters for the resource patch 202. As another example, the resource patch 202 utilizes the I/O 212 to execute a resource transaction. For example, a user associated with the resource patch 202 can store resources (e.g., transfer funds) on the resource patch 202 by utilizing the I/O 212 to communicate to the resource patch 202 the quantity of resources to be utilized for one or more resource transactions. Additionally, the user associated with the resource patch 202 can execute a resource transaction by placing the resource patch 202 near a vendor terminal such that the resource patch 202 communicates with the vendor terminal via the I/O 212 to execute a resource transaction utilizing the resources stored on the resource patch 202.

The memory 214 includes a control module 216 and data 218. The memory 214 typically comprises a variety of computer readable media. As an example, computer readable media can be any available media and comprises, for example and not meant to be limiting, both volatile and non-volatile media, removable and non-removable media, and so forth. The memory 214 can comprise computer readable media in the form of volatile memory, such as random access memory (RAM), and/or non-volatile memory, such as read only memory (ROM).

In another example, the memory 214 can also comprise other removable/non removable, volatile/non-volatile computer storage media. The memory 214 can provide non-volatile storage of computer code, computer readable instructions, data structures, program modules, and other data for the resource patch 202. For example, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

The memory 214 can store software that is executable by the processor 210, including operating systems, applications, and related software. The memory 214 also includes data 218. The data 218 comprises information related to the resources stored on the resource patch 202, as well as one or more settings, preferences, and/or operational parameters associated with the resource patch 202. As an example, the data 218 can include information such as a password that is required to utilize the resource patch 202, the number of resources allocated to the resource patch 202, including a maximum allowable number of resources, a timeframe that the resource patch 202 is active (e.g., a timeframe that a user can utilize the resource patch 202 to execute a resource transaction, as well as geographic restrictions (e.g., preventing the resource patch 202 from being used outside a pre-determined geographical area). Additionally, the data 218 can comprise information associated with a user of the resource patch 202. For example, the data 218 can comprise identifying information of the user to prevent unauthorized persons from utilizing the resource patch 202 to complete a resource transaction, as well as assist in returning the resource patch 202 to the user if the user misplaces (e.g., loses) the resource patch 202.

The resource patch 202 can also include an optional power supply 220. As explained above, the resource patch 202 can be configured as a passive electronic device such that the power supply 220 is not necessary for the resource patch 202 to operate. However, by utilizing the power supply 220, the amount of power available to the resource patch 202 can be increased to support additional electronic components, such as the processor 210, and allow for the capabilities of the resource patch 202 to be increased, as compared to a passive electronic device.

The power supply 220 can be any suitable method of providing power to the resource patch 202. While not shown for ease of explanation, the computing device 204 and/or the first networked device 104 can also comprise a power supply. The power supply 220 can include a battery (e.g., Lithium-Ion, alkaline, etc.), a direct power connection (e.g., wired) to an external source (e.g., 120 V, 240 V), and/or a wireless power connection (e.g., induction) to an external source. The power supply 220 can comprise one or more components configured to provide a constant voltage to the resource patch 202. The power supply 220 can also be configured to provide a stable current source to provide stable current to the resource patch 202. Further, as will be appreciated by one skilled in the art, the power supply 220 can include additional elements such as amplifiers, filters, and so forth. While a single power supply 220 is illustrated for ease of explanation, a person skilled in the art would appreciate additional power supplies 220 may be present that may include similar or different power sources.

The resource patch 202 can be configured to be impervious or resistant to external forces and/or elements (e.g., water, temperature, etc.). For example, the resource patch 202 can be configured to be waterproof or water resistant so that a user can use the resource patch 202 while performing one or more water related activities such as swimming, fishing, white water rafting, and so forth. The resource patch 202 can also be configured to be affixed to a surface. The resource patch 202 can be affixed to the surface by any means. For example, the resource patch 202 can have an adhesive (e.g., glue) placed on one side of the resource patch 202 to allow the resource patch 202 to be affixed to a surface. As an example, the resource patch 202 could function similar to a Band-Aid and be configured to be affixed to the skin of a user or affixed to a surface of an object that the user desires to couple the resource patch 202 with. As another example, the resource patch 202 could be configured to attach to a fingernail, such as via a fingernail polish or adhesive or as a fake nail designed to go over the top of a person's real nail.

As a further example, the resource patch 202 can be configured to function as a temporary tattoo and be affixed to the skin of the user and have the appearance of a temporary tattoo. The resource patch 202 can also be configured to have a decorative design or code (e.g., a Quick Response (QR) code) on an outward facing portion of the resource patch 202. For example, a QR code can be affixed permanently or temporarily (e.g., the QR code is removable) to assist the user of the resource patch 202 in registering and/or setting up the resource patch 202. As an example, the QR code can be associated with an instruction manual that a user can pull up by utilizing a computing device, such as a smartphone, to scan the QR code and pull up the instruction manual. As will be appreciated by one skilled in the art, there are a plurality of designs and/or styles that the resource patch 202 can utilize based on the tastes of a user and the present disclosure should be understood to incorporate differing styles, colors, and so forth.

The resource patch 202 can also be configured to incorporate one or more additional components that are not listed in FIG. 2. For example, the resource patch 202 can comprise a display (e.g., a touchscreen, a flexible display, etc.) that can provide information to the user. As an example, the display could indicate the remaining portion of the resources allocated to the resource patch 202, as well as one or more settings associated with the resource patch (e.g., remaining active time, error messages, etc.). The resource patch 202 can also be configured to have one or more input devices. For example, the resource patch 202 can comprise a biometric sensor to increase the security of the resource patch 202, as well as a touchscreen to receive inputs from the user.

The computing device 204 can be any computing device configured to communicate with the resource patch 202. For example, the resource patch 202 can comprise a terminal associated with a third party that allows for a user to process a resource transfer via the terminal. As an example, the user can place the resource patch 202 within communication range of the computing device 204 to initiate a resource transfer using the resources stored on the resource patch 202. Thus, the resource patch 202 can be utilized to execute a resource transfer so that the user of the resource patch 202 can make a purchase or transfer resources to another source.

The resource patch 202 can be configured to communicate with a user device (e.g., the first networked device 104) via the I/O 212. The first networked device 104 can comprise an application configured to communicate with a resource source or a resource network (e.g., the first resource application 122, the second resource application 174, etc.). The first networked device 104 can be configured to register and/or activate the resource patch 202, as well as modify one or more settings and/or operational parameters associated with the resource patch 202. For example, a user of the first networked device 104 can utilize an application on the first networked device 104 to register the resource patch 202. As an example, the user may acquire the resource patch 202 from a merchant (e.g., purchase the resource patch 202) or from another source (e.g., from another person or entity), and the user may utilize the first networked device 104 to register and/or activate the resource patch 202. For example, the resource patch 202 may need to be registered and/or activated before the resource patch 202 can be utilized for a resource transfer. Additionally, the user may utilize the first networked device 104 to modify one or more settings associated with the resource patch 202, such as enabling password protection on the resource patch 202, modifying and/or checking the status of the resource patch 202 (e.g., current funds, active time, geographical limitations, etc.). Additionally, the user can utilize the first networked device 104 to transfer fund between one or more resource patches 202. For example, the user may have several different resource patches 202, and the user can transfer funds among the various resource patches 202 via the first networked device 104. Further, the user can utilize the first networked device 104 to change the status of the resource patch 202. For example, the user may have misplaced (e.g., lost) the resource patch 202, and the user would desire to deactivate the resource patch 202, as well as transfer any remaining funds to another resource account, which the user can accomplish via the first networked device 104. Accordingly, the user can utilize a resource application associated with the first networked device 104 to modify one or more settings and/or operational parameters associated with the resource patch 202, as well as transfer funds to and/or from the resource patch 202.

In some embodiments, the resource patch 202 may have standard operating parameters. The resource patch 202 may have a pre-determined resource allocation and active timeframe that is automatically applied to the resource patch 202. For example, the resource patch 202 may be designed to function as gift card such that once a user of the resource patch 202 acquires and activates the resource patch 202, the resource patch 202 has standard operating parameters that are automatically applied to the resource patch 202. As an example, the resource patch 202 can be activated by a party other than the user (e.g., a resource network, a third party vendor, etc.) upon the user acquiring the resource patch 202 or before the user acquires the resource patch 202. Once activated, the resource patch 202 can have standard parameters applied that can be determined by the party other than the user. Thus, in some embodiments, the user is unable to modify one or more parameters associated with the resource patch 202.

Additionally, the resource patch 202 may include fewer components than those shown in FIG. 2. In some embodiments, the resource patch 202 may simply include the memory 214 and the I/O 212 to reduce the size and complexity of the resource patch 202. For example, the resource patch 202 may be a passive electronic device that is powered via wireless signals when the resource patch 202 comes within close contact to another electronic device (e.g., the computing device 204, the first networked device 104, etc.). As an example, the resource patch 202 can be configured to communicate via NFC and/or RFID, as well as be powered by the NFC and/or RFID signals, such that the resource patch 202 does not actively generate power or draw power unless the resource patch is within communication range of an NFC and/or RFID device, similar to the smart chips located within credit cards.

In these embodiments, the resource patch 202 the memory 214 may simply store an identifier that identifies the resource patch 202. The device communicating with the resource patch 202 (e.g., reading the resource patch 202), such as the first networked device 104, eth computing device 204, and so forth, may simply receive a signal from the resource patch 202 indicating the identifier associated with the resource patch 202. The device receiving the signal from the resource patch 202 may communicate with a resource network to determine an account associated with the resource patch 202. For example, the identifier from the resource patch 202 can indicate the resource patch is associated with a specific resource network so that the receiving device can determine where to query to determine one or more attributes of the resource patch 202. The receiving device can communicate with the specific resource network to determine the one or more attribute of the resource patch 202. As an example, the resource patch 202 can be associated with a resource account that has a certain amount of resources available on the resource network, and the resource network can facilitate completing a resource transaction with the resource patch 202. Thus, the receiving device can query the resource network to determine whether the resource account associated with the resource patch 202 has the resources necessary to complete a resource transaction. If the resource account associated with the resource patch 202 has the necessary resources, the resource network can transmit a notification to the receiving device indicating as much to allow the resource transaction to proceed.

Additionally, the resource account associated with the resource patch 202 can be easily secured if the resource patch 202 is a passive device. For example, when the resource patch 202 is a passive device and simply stores an identifier associated with a resource account, this means that no resources are stored on the resource patch 202. Thus, if the resource patch 202 is lost or misappropriated, there is no concern that the resources may be misappropriated as the resources are not stored on the resource patch 202, unlike a gift card or cash. Rather, the resources can be stored in a separate resource account associated with a user of the resource patch 202. If the user notices that the resource patch 202 is missing, or desires to dispose of, cancel, and/or deactivate the resource patch 202, the user simply needs to notify the resource network (e.g., via the first networked device 104) that the user desires to deactivate the resource patch 202. The resource network can receive the request from the user and update a database to indicate that the resource patch 202 is no longer active and should not be allowed to complete any resource transactions. Thus, the resource network can be configured to control operation of the resource patch 202.

Further, because the resource account can be separate from the resource patch 202, the user can request another resource patch 202 to replace the deactivated resource patch 202 and still be able to utilize the resources stored in the resource account. Additionally, when the resource patch 202 is a passive device, the user can modify one or more parameters associated with the resource patch 202. For example, the resource network associated with the resource patch 202 can store the one or more parameters (e.g., in memory) associated with the resource patch 202. The user can notify the resource network that the user desires to modify the one or more parameters and can transmit the modifications to the resource network (e.g., via the first networked device 104). The resource network can receive the requested modifications and update that the data associated with the resource patch 202 to reflect the requested modifications. The resource network can then utilize the one or more parameters associated with the resource patch 202 when determining whether to approve or deny a resource transaction associated with the resource patch 202. Thus, the user can modify the one or more parameters of the resource patch 202 via the resource network. Thus, in some embodiments, the size, the cost, and the complexity of the resource patch 202 can be reduced in order to produce a disposable (e.g., a replaceable) resource patch 202.

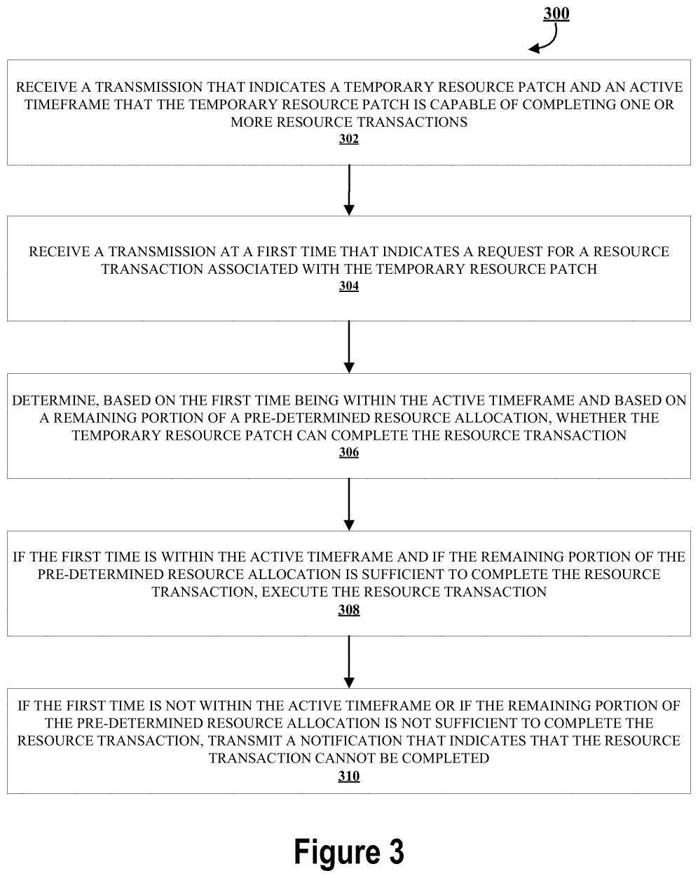

FIG. 3 illustrates a flowchart of an exemplary method 300. At block 302, a transmission that indicates a temporary resource patch and an active timeframe that the temporary resource patch is capable of completing one or more resource transactions is received. For example, a user associated with the temporary resource patch may activate and/or register the temporary resource patch in order to use the temporary resource patch for a resource transaction. The transmission can be received by a computing device (e.g., a user device, the recipient system 106 of FIG. 1, the processing system 108 of FIG. 1, etc.). The user may indicate the active timeframe and/or resource allocation for the temporary resource patch, or the active timeframe and/or resource allocation may be pre-determined. As an example, the temporary resource patch may have a pre-determined active timeframe (e.g., 1 week, 1 month, etc.), as well as pre-determined resource allocation (e.g., similar to a pre-determined gift card). As another example, the user may determine the active timeframe (e.g., several hours, a day, a year, etc.), as well as the resources allocated to the temporary resource patch. The temporary resource patch can be configured such that the user can modify the active timeframe and/or resource allocation. The data associated with the resource patch (e.g., settings, active timeframe, etc.) can be stored on the temporary resource patch, a resource network, or on a user device associated with the user.

At block 304, a transmission at a first time that indicates a request for a resource transaction associated with the temporary resource patch is received. For example, the user may attempt to purchase goods and/or services associated with a third party. The transmission may be received from a purchasing terminal associated with the third party that indicates the user is attempting to utilize the temporary resource patch for a resource transaction, and the third party may desire to confirm that the temporary resource patch is authorized to complete the requested transaction.

At block 306, whether the temporary resource patch can complete the resource transaction, based on the first time being within the active timeframe and based on a remaining portion of a pre-determined resource allocation, is determined. For example, the temporary resource patch can be configured to determine whether the temporary resource patch is still active (e.g., within the active timeframe at the time the request for the resource transfer is made), as well as the remaining resource allocation associated with the temporary resource patch. As another example, the temporary resource patch may be associated with a resource network (e.g., a bank) and/or a resource account of the resource network (e.g., a bank account), and the resource network needs to be queried to determine whether the temporary resource patch is authorized to complete the transaction, as well as determine whether the resource account has adequate resources to complete the resource transaction.

At block 308, if the first time is within the active timeframe and if the remaining portion of the pre-determined resource allocation is adequate to complete the resource transaction, the resource transaction is executed. For example, the temporary resource patch may be configured to determine the active timeframe associated with the temporary resource patch, as well as the remaining portion of the resource allocation associated with the temporary resource patch. Thus, in the aforementioned example, the temporary resource patch can make the determination and proceed with executing the resource transaction. As another example, the third party where the user is attempting the resource transaction may query a resource network associated with the temporary resource patch to determine whether the temporary resource patch is capable of completing the resource transaction. Thus, in the aforementioned example, the resource network can make the determination and proceed with executing the resource transaction.

At block 310, if the first time is not within the active timeframe or if the remaining portion of the pre-determined resource allocation is not adequate to complete the resource transaction, a notification that indicates that indicates that the resource transaction cannot be complete is transmitted. For example, the temporary resource patch may be configured to determine the active timeframe associated with the temporary resource patch, as well as the remaining portion of the resource allocation associated with the temporary resource patch. Thus, in the aforementioned example, the temporary resource patch can make the determination that the temporary resource patch cannot complete the transaction and transmit the notification to another device. For example, the notification indicating that the transaction cannot be completed can be transmitted to a user device associated with the user of the temporary resource patch, the notification can be transmitted to the third party, and/or the notification can be transmitted to a resource network associated with the temporary resource patch. As another example, the third party where the user is attempting the resource transaction may query a resource network associated with the temporary resource patch to determine whether the temporary resource patch is capable of completing the resource transaction. Thus, in the aforementioned example, the resource network can make the determination that the temporary resource patch is not capable of processing the resource transaction and can transmit the notification to another device. For example, the notification can be transmitted to a user device associated with the user of the temporary resource patch, the notification can be transmitted to the third party, and/or the notification can be transmitted to the temporary resource patch to prevent the temporary resource patch from executing the transaction.

In another embodiment, a transmission that indicates the temporary resource patch is received from a user device. The transmission can comprise an identifier associated with the temporary resource patch. The temporary resource patch can be associated with a resource account associate with a user of the user device based on the identifier. For example, the user may register and/or activate the temporary resource patch and can connect the temporary resource patch with the user's resource account in order to transfer funds to and/or from the temporary resource patch. A notification indicating that the temporary resource patch is associated with the resource account is transmitted via a resource application associated with the user device. For example, the user may utilize a resource application on the user device to register and/or activate the temporary resource patch, and once the temporary resource patch is registered and/or activated, the user may receive a notification via the resource application.

In another embodiment, if the resource transaction cannot be completed, a query is transmitted, via the resource application, as to whether the user desires to complete the resource. For example, the temporary resource patch and/or the resource network can send the notification to the resource application. A response from the user that indicates that the user desires to complete the resource transaction can be received via the resource application. For example, the user may interact with a prompt via the resource application that indicates whether the user desires to complete the resource transaction. If the remaining portion of the pre-determined resource allocation is not adequate to complete the resource transaction, a quantity of the resource adequate to complete the transaction can be transferred from the resource account to the temporary resource patch. For example, the resource network can transfer the funds from the resource account to the temporary resource patch to allow the user to complete the transaction. If the first time is not within the active timeframe, the active timeframe can be modified such that the first time is within the active timeframe. For example, the active timeframe for the temporary resource patch can be extended in order to allow the user to complete the resource transaction. A notification that indicates that the temporary resource patch is capable of completing the resource transaction can be transmitted via the resource application.

In another embodiment, an indication that the user desires to modify one or more settings associated with the temporary resource patch is received via the resource application. The user device and/or the resource network may receive the indication. For example, the user may manipulate an interface prompt associated with the resource application that indicates the user desires to modify the one or more settings. The one or more settings can comprise at least one of the pre-determined resource allocation, the active timeframe, a geographical region where the temporary resource patch is active, one or more resource accounts associated with the temporary resource patch, and/or one or more users associated with the temporary resource patch. A transmission that indicates the one or more settings the user desires to modify can be transmitted to the temporary resource patch based on the indication that the user desires to modify the one or more settings associated with the temporary resource patch. For example, the user device and/or the resource network can transmit the transmission to the temporary resource patch. The temporary resource patch can be configured to modify the one or more settings associated with the temporary resource patch. An indication that the one or more settings the user desires to modify have been modified can be received from the temporary resource patch. For example, the user device and/or the resource network can receive the indication. A confirmation that indicates that the one or more settings the user desires to modify have been modified can be transmitted via the resource application.

In another embodiment, an indication that the user desires to associate a password with the temporary resource patch can be received via the resource application. For example, the user can utilize the resource application to indicate that the user desires to password protect the resource patch. The password can be a Personal Identification Number (PIN) or another password. The password that the user desires to associate with the temporary resource patch may be received via the resource application. For example, the user can input into the resource application the password. A transmission that indicates the password the user desires to associate with the temporary resource patch can be transmitted to the temporary resource patch. For example, the user device and/or the resource network can send the transmission to the temporary resource patch. The temporary resource patch can be configured to prevent completion of one or more resource transactions without receiving an indication of the password. For example, after associating the password with the temporary resource patch, the temporary resource patch may require the user to enter the password before attempting to complete a resource transaction and/or modify one or more settings associated with the temporary resource patch. An indication that the temporary resource patch successfully implemented the password can be received from the temporary resource patch. For example, the user device and/or the resource network can receive the indication. A confirmation that indicates that the temporary resource patch is associated with the password can be transmitted via the resource application. For example, the resource application can display the confirmation that the password was successfully associated with the temporary resource patch.

In another embodiment, an indication that the user desires to de-activate the temporary resource patch can be received via the resource application. For example, the user can indicate via the resource application that they no longer wish to use the temporary resource patch and/or the user misplaced the temporary resource patch, and the user wants to deactivate the temporary resource patch so that any resources associated with the temporary resource patch cannot be used. The remaining portion of the pre-determined resource allocation can be transferred to the resource account associated with the user. Data that indicates that the temporary resource patch is de-activated can be stored within a memory resource. For example, the temporary resource patch, the user device, and/or the resource network can store data that indicates the temporary resource patch has been deactivated to ensure that the temporary resource patch is not utilized for a resource transaction. A notification that indicates that the temporary resource patch is de-activated can be transmitted to the resource network. A confirmation that indicates that the temporary resource patch is de-activated and that the remaining portion of the pre-determined resource allocation was transferred to the resource account associated with the user can be transmitted via the resource application.

In another embodiment, the temporary resource patch is further configured to be affixed on a person, and the temporary resource patch is further configured to be disposable. For example, the temporary resource patch can be configured to resemble a band aid and is configured to be disposed of (e.g., thrown out) once the user is finished with the temporary resource patch.

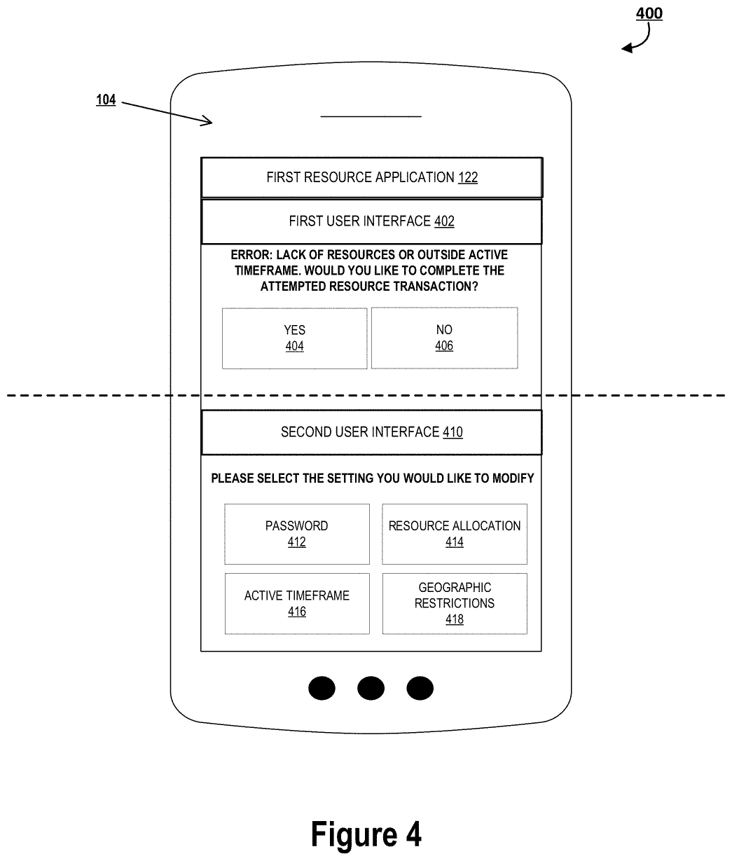

FIG. 4 illustrates an exemplary user interface 400 of a device. The first networked device 104 may display on a screen the first resource application 122. The first resource application 122 can facilitate communicating with a resource patch (e.g., the temporary resource patch 202 of FIG. 2). The first resource application 122 can have a first user interface 402 that is associated with one or more resource patches associated with a user of the user device 104. For example, the first resource application 122 can display one or more graphical prompts 404, 406 associated with the resource patch. As shown, the first user interface 402 notifies and/or informs the user that there is an error with trying to complete a resource transaction associated with the resource patch, and queries the user as to whether the user desires to complete the attempted resource transaction. The first user interface 402 can display one or more options below the notification. Specifically, the first user interface 402 displays a graphical prompt 404 that indicates “YES” that the user desires to complete the attempted resource transaction, and a graphical prompt 406 that indicates “NO” that the user desires to complete the attempted resource transaction.

The user may input a response via an input device such as a touchscreen, keyboard, pointing device, etc. or verbally to a microphone of the first networked device 104. Based on the user's response, the first resource application 122 can take one more actions. For example, if the user desires to complete the attempted resource transaction, the first resource application 122 can increase the resources or modify the active timeframe associated with the resource patch so that the resource patch is capable of completing the transaction. As another example, the first resource application 122 can notify a resource network that the user desires to complete the attempted resource transaction so that the resource network can take one or more steps to facilitate completing the resource transaction.

The first resource application 122 can have a second user interface 410. As shown, the second user interface 410 indicates to the user to select a setting that the user desires to modify. For example, the first resource application 122 can display one or more graphical prompts 412, 414, 416, 418 associated with one or more settings associated with the resource patch. Specifically, graphical prompt 412 indicates the user desires to modify and/or generate a password associated with the resource patch, graphical prompt 414 indicates that the user desires to modify a resource allocation associated with the resource patch, graphical prompt 416 indicates that the user desires to modify the active timeframe associated with the resource patch, and graphical prompt 418 indicates that the user desires to modify the geographic restrictions associated with the resource patch. Based on the user's response (e.g., which graphical prompt the user selects), the first resource application 122 can take one more actions. For example, if the user desires to modify one of the settings, the first resource application 122 can provide an additional user interface (not shown) that prompts the user to indicate the modification that the user would like to make the selected setting. As another example, the first resource application 122 can notify a resource network and/or the resource patch that the user desires to modify a setting and/or provide the modification to the setting that the user desires so that the resource network and/or the resource patch can take one or more steps to facilitate modifying the setting as desired by the user. For example, if the user desires to modify the geographic restrictions of the resource patch (e.g., geographically where the resource patch can and cannot be used), the first resource application 122 can indicate to the user to input where the user desires to the resource patch to be active and/or inactive. Some non-limiting examples of geographical restrictions include limiting the ability to use the resource patch to a specific country, city, zip code, region, store, and so forth. The first resource application 122 can then store this information and/or send this information to the resource patch and/or the resource network to ensure the resource patch is only utilized in approved geographic regions.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for electronic completion of a resource transaction transfer using a temporary resource patch, the system comprising:
at least one memory device;
at least one communication device connected to a communications network; and
at least one processing device operatively coupled to the at least one memory device
the at least one processing device performs:
provide the temporary resource patch for affixing to a user using adhesive, wherein the temporary resource patch communicates with a computing device;
receive a transmission requesting the temporary resource patch for electronic completion of the resource transaction, wherein the transmission further comprises an active timeframe for the temporary resource patch activity and a pre-determined resource allocation for the temporary resource patch activity;
receive, at a first time a request for the resource transaction associated with the temporary resource patch;
determine, based on the first time being within the active timeframe and based on a remaining portion of the pre-determined resource allocation, whether the temporary resource patch can complete the resource transaction;
confirm that the first time is within the active timeframe and is within the predetermined resource allocation and allow execution of the resource transaction; and
deactivate the temporary resource patch.

2. The system of claim 1, further comprising:
receiving an identifier associated with the temporary resource patch;
associating, based on the identifier, the temporary resource patch with a resource account associated with a user of the user device; and
transmitting, via a resource application associated with the user device, a notification indicating that the temporary resource patch is associated with the resource account.

3. (canceled)

4. The system of claim 1, further comprising:
receiving an indication that the user desires to modify one or more settings associated with the temporary resource patch, wherein the one or more settings comprise at least one of the pre-determined resource allocation, the active timeframe, a geographical region where the temporary resource patch is active, one or more resource accounts associated with the temporary resource patch, or one or more users associated with the temporary resource patch;
transmitting to the temporary resource patch based on the indication that the user desires to modify the one or more settings associated with the temporary resource patch, a transmission that indicates the one or more settings the user desires to modify, wherein the temporary resource patch modifies the one or more settings associated with the temporary resource patch;
and
transmitting a confirmation that indicates that the one or more settings the user desires to modify have been modified.

5. The system of claim 1, further comprising:
receiving an indication that the user desires to associate a password with the temporary resource patch; and
preventing completion of one or more resource transactions without receiving an indication of the password.

6. The system of claim 1, further comprising:
receiving an indication that the user desires to deactivate the temporary resource patch;
transferring the remaining portion of the pre-determined resource allocation to the resource account associated with the user;
storing data that indicates that the temporary resource patch is deactivated;
and
transmitting a confirmation that indicates that the temporary resource patch is deactivated and that the remaining portion of the pre-determined resource allocation was transferred to the resource account associated with the user.

7. The system of claim 1, wherein the temporary resource patch is disposable.

8. A computer program product for electronic completion of a resource transfer using a temporary resource patch, the computer program product comprising a non-transitory computer-readable storage medium having computer-readable program code portions embodied therein, the computer-readable program code portions comprising:
providing the temporary resource patch for affixing to a user using adhesive, wherein the temporary resource patch communicates with a computing device;
receiving a transmission requesting the temporary resource patch for electronic completion of the resource transaction, wherein the transmission further comprises an active timeframe for the temporary resource patch activity and a pre-determined resource allocation for the temporary resource patch activity;
receiving, at a first time a request for the resource transaction associated with the temporary resource patch;
determining, based on the first time being within the active timeframe and based on a remaining portion of the pre-determined resource allocation, whether the temporary resource patch can complete the resource transaction;
confirm that the first time is within the active timeframe and is within the pre-determined resource allocation and allow execution of the resource transaction; and
deactivating the temporary resource patch.

9. The computer program product of claim 8, further comprising:
receiving an identifier associated with the temporary resource patch;
associating, based on the identifier, the temporary resource patch with a resource account associated with a user of the user device; and
transmitting, via a resource application associated with the user device, a notification indicating that the temporary resource patch is associated with the resource account.

10. (canceled)

11. The computer program product of claim 8, further comprising:
receiving, via the resource application, an indication that the user desires to modify one or more settings associated with the temporary resource patch, wherein the one or more settings comprise at least one of the pre-determined resource allocation, the active timeframe, a geographical region where the temporary resource patch is active, one or more resource accounts associated with the temporary resource patch, or one or more users associated with the temporary resource patch;
transmitting, to the temporary resource patch based on the indication that the user desires to modify the one or more settings associated with the temporary resource patch, a transmission that indicates the one or more settings the user desires to modify, wherein the temporary resource patch modifies the one or more settings associated with the temporary resource patch;
and
transmitting, via the resource application, a confirmation that indicates that the one or more settings the user desires to modify have been modified.

12. The computer program product of claim 8, further comprising:
receiving an indication that the user desires to associate a password with the temporary resource patch; and
preventing completion of one or more resource transactions without receiving an indication of the password.

13. The computer program product of claim 8, further comprising:
receiving, via the resource application, an indication that the user desires to deactivate the temporary resource patch;
transferring the remaining portion of the pre-determined resource allocation to the resource account associated with the user;
storing, within a memory resource, data that indicates that the temporary resource patch is deactivated;
and
transmitting, via the resource application, a confirmation that indicates that the temporary resource patch is de activated and that the remaining portion of the pre-determined resource allocation was transferred to the resource account associated with the user.

14. The computer program product of claim 8, wherein the temporary resource patch is disposable.

15. A computer-implemented method for electronic completion of a resource transfer using a temporary resource patch, the method comprising:
providing the temporary resource patch for affixing to a user using adhesive, wherein the temporary resource patch communicates with a computing device;
receiving a transmission requesting the temporary resource patch for electronic completion of the resource transaction, wherein the transmission further comprises an active timeframe for the temporary resource patch activity and a pre-determined resource allocation for the temporary resource patch activity;
receiving, at a first time a request for the resource transaction associated with the temporary resource patch;
determining, based on the first time being within the active timeframe and based on a remaining portion of the pre-determined resource allocation, whether the temporary resource patch can complete the resource transaction;
confirming that the first time is within the active timeframe and is within the predetermined resource allocation and allow execution of the resource transaction; and
deactivating the temporary resource patch.

16. The computer-implemented method of claim 15, further comprising:
receiving an identifier associated with the temporary resource patch;
associating, based on the identifier, the temporary resource patch with a resource account associated with a user of the user device; and
transmitting, via a resource application associated with the user device, a notification indicating that the temporary resource patch is associated with the resource account.

17. (canceled)

18. The computer-implemented method of claim 15, further comprising:
receiving an indication that the user desires to modify one or more settings associated with the temporary resource patch, wherein the one or more settings comprise at least one of the pre-determined resource allocation, the active timeframe, a geographical region where the temporary resource patch is active, one or more resource accounts associated with the temporary resource patch, or one or more users associated with the temporary resource patch;
transmitting, to the temporary resource patch based on the indication that the user desires to modify the one or more settings associated with the temporary resource patch, a transmission that indicates the one or more settings the user desires to modify, wherein the temporary resource patch modifies the one or more settings associated with the temporary resource patch;
and
transmitting a confirmation that indicates that the one or more settings the user desires to modify have been modified.

19. The computer-implemented method of claim 15, further comprising:
receiving an indication that the user desires to associate a password with the temporary resource patch; and
preventing completion of one or more resource transactions without receiving an indication of the password.

20. The computer-implemented method of claim 15, further comprising:
receiving an indication that the user desires to de activate the temporary resource patch;
transferring the remaining portion of the pre-determined resource allocation to the resource account associated with the user;
storing data that indicates that the temporary resource patch is deactivated;
and
transmitting a confirmation that indicates that the temporary resource patch is deactivated and that the remaining portion of the pre-determined resource allocation was transferred to the resource account associated with the user.
